(19) United States
(12) Patent Application Publication
(10) Pub. No.: US 2019/0001258 A1
(43) Pub. Date: Jan. 3, 2019

(54) CARBON-DIOXIDE-REDUCING FILM, MANUFACTURING METHOD THEREOF, AND CARBON-DIOXIDE-REDUCING APPARATUS

(71) Applicant: FUJITSU LIMITED, Kawasaki-shi (JP)

(72) Inventors: Toshio MANABE, Atsugi (JP); Yoshihiko Imanaka, Atsugi (JP); Toshihisa Anazawa, Sagamihara (JP); Hideyuki AMADA, Atsugi (JP)

(73) Assignee: FUJITSU LIMITED, Kawasaki-shi (JP)

(21) Appl. No.: 16/019,709

(22) Filed: Jun. 27, 2018

(30) Foreign Application Priority Data
Jun. 29, 2017 (JP) 2017-127455

(51) Int. Cl. B01D 53/14; B01D 71/02; C01B 32/168

(52) U.S. Cl. CPC B01D 53/1475; B01D 71/021; C01B 32/168; C25B 3/04; C01B 2202/02; C01B 2202/06; B01D 2253/102

(57) ABSTRACT

A carbon-dioxide-reducing film includes, an electrically conductive material, a carbon-dioxide adsorbent, and a proton-permeable high-molecular-weight material. The electrically conductive material includes at least one selected from a group consisting of carbon nanotubes, nanographenes, and carbon paper.

### CROSS-REFERENCE TO RELATED APPLICATION

This application is based upon and claims the benefit of priority of the prior Japanese Patent Application No. 2017-127455, filed on Jun. 29, 2017, the entire contents of which are incorporated herein by reference.

### FIELD

The embodiments discussed herein are related to a carbon-dioxide-reducing film, a manufacturing method thereof, and a carbon-dioxide-reducing apparatus.

### BACKGROUND

Since awareness of global warming has been raised, cutting of carbon dioxide emitted into the air as a result of industrial activities has been an important issue.

In recent years, an artificial photosynthesis technology has attracted attention as a method for reducing carbon dioxide in the air. The artificial photosynthesis technology is a technology to reduce carbon dioxide by using solar energy to cause conversion of carbon dioxide to a usable organic compound. The artificial photosynthesis technology generates electrons and protons by irradiating a photoexcitation material placed on an anode with sunlight in a bath including an electrolytic solution. The resulting electrons and protons are fed to a reducing catalyst placed on a cathode so as to react with carbon dioxide and, as a result, carbon monoxide and organic compounds are generated. A cathode reaction at this time is a kind of electrolytic reduction, and on the catalyst of the cathode, carbon dioxide reacts with two electrons and two protons in stages so as to be reduced to formic acid or carbon monoxide, to formaldehyde, to methanol, and to methane, where substance utility increases in this order.

In common electrolytic reduction methods, an electrochemical cell including a working electrode, a counter electrode, and a bath is used.

International Publication Pamphlet No. WO 2011/132375 discusses a related technology.

### SUMMARY

According to an aspect of the embodiments, a carbon-dioxide-reducing film includes, an electrically conductive material, a carbon-dioxide adsorbent, and a proton-permeable high-molecular-weight material. The electrically conductive material includes at least one selected from a group consisting of carbon nanotubes, nanographenes, and carbon paper.

The object and advantages of the invention will be realized and attained by means of the elements and combinations particularly pointed out in the claims. It is to be understood that both the foregoing general description and the following detailed description are exemplary and explanatory and are not restrictive of the invention, as claimed.

### BRIEF DESCRIPTION OF DRAWINGS

FIG. 1 is a schematic sectional view of an example of a carbon-dioxide-reducing film;

FIG. 2 is a schematic sectional view of an example of a carbon-dioxide-reducing apparatus;

FIG. 3 is a schematic sectional view of another example of a carbon-dioxide-reducing apparatus;

FIG. 4 is a diagram illustrating measurement results of electrical resistivity of each of comparative example 1, examples 1 to 3, and reference examples 1 to 4 and 6;

FIG. 5 is a diagram illustrating an adsorption isotherm of each of comparative example 1, example 2, and reference examples 1 to 6;

FIG. 6 is a diagram illustrating alternating current impedance spectra of example 1;

FIG. 7 is a diagram illustrating a cyclic voltammogram of each of examples 1 and 2 and comparative example 4; and

FIG. 8 is a diagram illustrating a cyclic voltammogram of each of example 3 and comparative example 4.

### DESCRIPTION OF EMBODIMENTS

Regarding electrolytic reduction of carbon dioxide, to enhance reaction efficiency, it is important to hold carbon dioxide in a reaction field in which carbon dioxide is reduced and to supply protons to the reaction field in which carbon dioxide is reduced. However, the related art is inadequate from the viewpoint of holding carbon dioxide in a reaction field in which carbon dioxide is reduced and supplying protons to the reaction field. As a result, it has been difficult to efficiently reduce carbon dioxide.

Carbon-Dioxide-Reducing Film

The carbon-dioxide-reducing film according to the present disclosure contains an electrically conductive material, a carbon-dioxide adsorbent, and a proton-permeable high-molecular-weight material, preferably contains a metal that can reduce carbon dioxide, and contains other components, as the situation demands. The carbon-dioxide adsorbent preferably contains a metal that can reduce carbon dioxide.

Regarding electrolytic reduction, it is important for enhancing the reaction efficiency to supply carbon dioxide, protons, and electrons to the reaction field. The present inventors noted a carbon-dioxide adsorbent represented by a porous metal complex having pores. Initially, an investigation was performed in which the carbon-dioxide adsorbent was arranged on an electrode (in an electrode) and electrolysis was performed in a state in which carbon dioxide was adsorbed and held by the carbon-dioxide adsorbent. When a carbon-dioxide adsorbent having a large amount of adsorption is arranged on the electrode, carbon dioxide can be reliably supplied, and an increase in reducing reaction efficiency can be expected. Next, there are issues of how to supply electrons and protons that react with carbon dioxide present on the carbon-dioxide adsorbent and how to cause contact with a catalyst that reduces carbon dioxide.

In many cases, the carbon-dioxide adsorbent represented by a porous metal complex is not electrically conductive. Consequently, it is difficult to supply electrons throughout the carbon-dioxide adsorbent by using only the carbon-dioxide adsorbent, and the reducing reaction does not advance when a catalytic metal is not present in the neighborhood. Meanwhile, even when a carbon-dioxide adsorbent powder is simply fixed to an electrode by an electrically conductive paste or the like, it is difficult to supply electrons to pore portions in which carbon dioxide is adsorbed. In a carbon-dioxide-reducing apparatus in the related art, protons are moved by using an electrolytic solution. When the electrolytic solution is used, protons are moved smoothly. However, use of an electrolytic solution causes a problem in that pores of the carbon-dioxide adsorbent are blocked with water so as to decrease the amount of carbon dioxide adsorbed. In addition, use of an electrolytic solution causes problems in that an electrode material peels and that a product is not readily recovered. As a result, a method in which protons are smoothly transferred without recourse to the electrolytic solution is desired. As described above, it is difficult to ensure compatibility between an increase in the amount of carbon dioxide adsorbed and smooth movement of electrons and protons. The present inventors performed repeated research. As a result, it was found that a carbon-dioxide-reducing film containing an electrically conductive material, a carbon-dioxide adsorbent, and a proton-permeable high-molecular-weight material had excellent carbon dioxide holding ability and had excellent proton conductivity without using an electrolytic solution, and the present disclosure was realized.

There is no particular limitation regarding the shape and the size of the carbon-dioxide-reducing film, and appropriate selection can be performed in accordance with a purpose. There is no particular limitation regarding the thickness of the carbon-dioxide-reducing film. The thickness can be appropriately selected in accordance with a purpose and is preferably 0.1 mm to 0.3 mm.

Electrically Conductive Material

There is no particular limitation regarding the electrically conductive material, and appropriate selection can be performed in accordance with a purpose. Examples of the electrically conductive material include electrically conductive carbon materials. Examples of electrically conductive carbon materials include single-walled carbon nanotubes, multi-walled carbon nanotubes, nanographenes, and carbon paper.

Preferably, the electrically conductive material has a functional group that can coordinate with a metal capable of reducing carbon dioxide, as described later. Examples of the functional group include a carboxy group, a hydroxy group, an amino group, an imino group, a thiol group, and an oxime group.

Preferably, the electrically conductive material is bonded to a metal capable of reducing carbon dioxide. Examples of bonds include an ionic bond and a coordinate bond.

There is no particular limitation regarding the method for providing a functional group to the electrically conductive material, and appropriate selection can be performed in accordance with a purpose. Examples of the method include a method in which an electrically conductive material having no functional group is dipped into a mixed acid.

There is no particular limitation regarding the content of the electrically conductive material, and appropriate selection can be performed in accordance with a purpose. The content is preferably 1% by mass to 10% by mass, and more preferably 2% by mass to 5% by mass relative to the carbon-dioxide adsorbent described later. If the content of the electrically conductive material is less than 1% by mass relative to the carbon-dioxide adsorbent, predetermined electrical conductivity is not obtained in some cases. If the content of the electrically conductive material is more than 10% by mass relative to the carbon-dioxide adsorbent, the total mass of the carbon-dioxide-reducing film increases. As a result, the amount of carbon dioxide adsorbed per unit mass of the carbon-dioxide-reducing film may decrease.

Carbon-Dioxide Adsorbent

Preferably, the carbon-dioxide adsorbent contains a metal that can reduce carbon dioxide. Examples of the carbon-dioxide adsorbent include silica configured to carry the metal that can reduce carbon dioxide, activated carbon, and a porous metal complex containing a metal that can reduce carbon dioxide as a central metal. In particular, the porous metal complex is preferable from the viewpoint of electrical connection to the electrically conductive material.

Porous Metal Complex

The porous metal complex contains a metal and a ligand that can coordinate with the metal. The porous metal complex (MOF) may also be called a porous coordination polymer (PCP).

Metal

Preferably, the metal serves as a catalyst that reduces carbon dioxide. Examples of the metal include titanium, manganese, iron, cobalt, nickel, magnesium, copper, zinc, aluminum, and zirconium. These may be used alone, or at least two types may be used in combination.

The metal is a so-called central metal in a metal complex.

Ligand

There is no particular limitation regarding the ligand as long as coordination with a metal (central metal) is possible, and appropriate selection can be performed in accordance with a purpose. Examples of the ligand include anionic ligands.

Examples of anionic ligands include the following anions.

Halide ions, e.g., a fluoride ion, a chloride ion, a bromide ion, and an iodide ion;

Inorganic acid ions, e.g., a tetrafluoroborate ion, a hexafluorosilicate ion, a hexafluorophosphate ion, a hexafluoroarsenate ion, and a hexafluoroantimonate ion;

Sulfonate ions e.g., a trifluoromethane sulfonate ion and a benzene sulfonate ion;

Aliphatic monocarboxylate ions, e.g., a formate ion, an acetate ion, a trifluoroacetate ion, a propionate ion, a butyrate ion, an isobutyrate ion, a valerate ion, a caproate ion, an enanthate ion, a cyclohexanecarboxylate ion, a caprylate ion, an octylate ion, a pelargonate ion, a caprate ion, a laurate ion, a myristate ion, a pentadecanoate ion, a palmitate ion, a margarate ion, a stearate ion, a tuberculostearate ion, an arachidate ion, a behenate ion, a lignocerate ion, an α-linolenate ion, an eicosapentaenoate ion, a docosahexaenoate, a linoleate ion, and an oleate ion;

Aromatic monocarboxyate ions, e.g., a benzoate ion, a 2,5-dihydroxybenzoate ion, a 3,7-dihydroxy-2-naphthoate ion, a 2,6-dihydroxy-1-naphthoate ion, and a 4,4′-dihydoxy-3-biphenylcarboxylate ion Heteroaromatic monocarboxyate ions, e.g., a nicotinate ion and an isonicotinate ion;

Aliphatic dicarboxylate ions, e.g., a 1,4-cyclohexanedicarboxylate ion and a fumarate ion;

Aromatic dicarboxyate ions, e.g., a 1,3-benzenedicarboxylate ion, a 5-methyl-1,3-benzenedicarboxylate ion, a 1,4-benzenedicarboxylate ion, a 1,4-naphthalenedicarboxylate ion, a 2,6-naphthalenedicarboxylate ion, a 2,7-naphthalenedicarboxylate ion, and a 4,4′-biphenyldicarboxylate ion;

Heteroaromatic dicarboxylate ions, e.g., a 2,5-thiophenedicarboxylate ion, a 2,2′-dithiophenedicarboxylate ion, a 2,3-pyrazinedicarboxylate ion, a 2,5-pyridinedicarboxylate ion, and a 3,5-pyridinedicarboxylate ion;

Aromatic tricarboxyate ions, e.g., a 1,3,5-benzenetricarboxylate ion, a 1,3,4-benzenetricarboxylate ion, and a biphenyl-3,4′,5-tricarboxylate ion;

Aromatic tetracarboxylate ions, e.g., a 1,2,4,5-benzenetetracarboxylate ion, a [1,1′:4′,1″]terphenyl-3,3″,5,5″-tetracarboxylate ion, and a 5,5′-(9,10-anthracenediyl)diisophthalate ion; and

Heterocyclic compound ions, e.g., an imidazolate ion, a 2-methylimidazolate ion, and a benzoimidazolate ion

Here, the anionic ligand refers to a ligand in which a site that coordinates with a metal ion has an anionic property.

In particular, anionic ligands having at least one functional group selected from a carboxy group, a hydroxy group, an amino group, an imino group, a thiol group, a carboxylate group, and an oxime group are preferable. Among these, anionic ligands having a carboxylate group are more preferable. That is, an anion selected from aliphatic monocarboxyate ions, aromatic monocarboxyate ions, heteroaromatic monocarboxyate ions, aliphatic dicarboxyate ions, aromatic dicarboxyate ions, heteroaromatic dicarboxyate ions, aromatic tricarboxyate ions, and aromatic tetracarboxyate ions is preferable.

Preferably, the ligand has at least one aromatic hydrocarbon ring and two pairs of a carboxy group and a hydroxy group, the two pairs being bonded to the at least one aromatic hydrocarbon ring, where a carboxy group of one pair of a carboxy group and a hydroxy group is bonded to one carbon atom of two adjacent carbon atoms of the at least one aromatic hydrocarbon ring, and a hydroxy group of the one pair is bonded to the other carbon atom, and the same applies to the other pair in the same manner as a compound denoted by the structural formula described below (2,5-dihydroxyterephthalic acid). As a result, a porous structure is readily formed in the same manner as M₂(dobdc) [M/DOBDC complex].

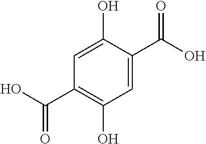 [SMILES: O=C(O)c1cc(O)c(C(=O)O)cc1O]

Regarding the porous metal complex in which a ligand is coordinated with a metal so as to form a porous structure, for example, M/DOBDC complexes (M=Ni, Mg, Co, and the like) are known, as described in N. L. Rosi, J. Kim, M. Eddaoudi, B. Chen, M. O'Keeffe, and O. M. Yaghi, J. Am. Chem. Soc., 127, 1504-1518, 2005; P. D. C. Dietzel, B. Panella, M. Hirsher, R. Blom, and H. Fjellvag, Chem. Commun., 959, 2006; S. R. Caskey, A. G. Wong-Foy, and A. J. Matzger, J. Am. Chem. Soc., 130, 10870-10871, 2008; P. D. C. Dietzel, V. Besikiotis, and R. Blom, J. Mater. Chem., 19, 7362-7370, 2009; and J. Liu, J. Tian, P. K. Thallapally, and B. P. McGrail, J. Phys. Chem. C, 116, 9575-9581, 2012.

Examples of the method for producing the porous metal complex include a production method described in Ru-Qiang Zou, Hiroaki Sakurai, Song Han, Rui-Qin Zhong, and Qiang Xu, J. Am. Chem. Soc., 129, 8402-8403, 2007.

Proton-Permeable High-Molecular-Weight Material

The proton-permeable high-molecular-weight material refers to a high-molecular-weight material, a film of which passes through almost only protons and hardly any other substances when the high-molecular-weight material is made into the film. There is no particular limitation regarding the proton-permeable high-molecular-weight material as long as the above-described features are provided, and appropriate selection can be performed in accordance with a purpose. For example, Nafion (registered trademark) may be used. In this regard, Nafion is a perfluorocarbon material formed from a hydrophobic Teflon (registered trademark) skeleton composed of carbon-fluorine (carbon atoms and fluorine atoms) and a perfluoro side chain having a sulfonate group. Specifically, Nafion is a copolymer of tetrafluoroethylene and perfluoro[2-(fluorosulfonylethoxy)propyl vinyl ether].

There is no particular limitation regarding the content of the proton-permeable high-molecular-weight material, and appropriate selection can be performed in accordance with a purpose. The content of the proton-permeable high-molecular-weight material is preferably 30% by mass to 50% by mass relative to a total mass of the electrically conductive material and the carbon-dioxide adsorbent. If the content of the proton-permeable high-molecular-weight material is less than 30% by mass relative to a total mass of the electrically conductive material and the carbon-dioxide adsorbent, predetermined proton conductivity is not obtained in some cases. If the content of the proton-permeable high-molecular-weight material is more than 50% by mass relative to a total mass of the electrically conductive material and the carbon-dioxide adsorbent, the amount of carbon dioxide adsorbed may decrease.

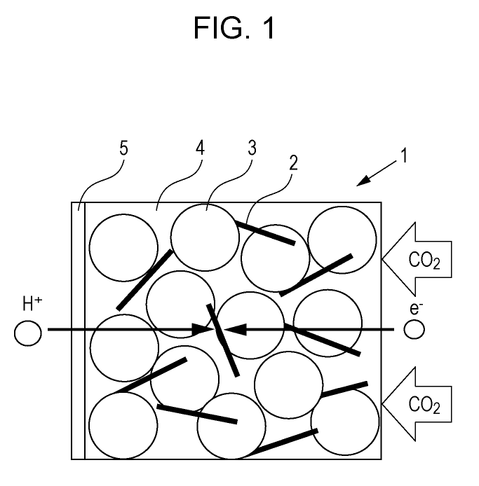

An example of the carbon-dioxide-reducing film will be described with reference to the drawings. FIG. 1 is a schematic sectional view in which a carbon-dioxide-reducing film 1 is disposed on a substrate 5. The carbon-dioxide-reducing film 1 includes an electrically conductive material 2, a carbon-dioxide adsorbent 3, and a proton-permeable high-molecular-weight material 4.

Method for Producing Carbon-Dioxide-Reducing Film

A method for producing a carbon-dioxide-reducing film according to the present disclosure includes a heating step and other steps, as the situation demands.

Heating Step

The heating step is a step in which a substrate is coated with a compound material and heated. There is no particular limitation regarding a method for applying the composite material, and appropriate selection can be performed in accordance with a purpose. In the heating step, there is no particular limitation regarding the heating temperature, and appropriate selection can be performed in accordance with a purpose. For example, the heating temperature may be 100° C. to 250° C. There is no particular limitation regarding the heating time, and appropriate selection can be performed in accordance with a purpose. For example, the heating time may be 1 minute to 5 minutes. Preferably, the heating step includes pressure bonding.

Substrate

There is no particular limitation regarding the substrate, and appropriate selection can be performed in accordance with a purpose. Preferably, a proton-permeable high-molecular-weight material is used. The above-described materials for the proton-permeable high-molecular-weight material can be used. There is no particular limitation regarding the size, thickness, and shape of the substrate, and appropriate selection can be performed in accordance with a purpose.

Composite Material

The composite material contains an electrically conductive material, a carbon-dioxide adsorbent, and a proton-permeable high-molecular-weight material, and may contain other components, as the situation demands. The above-described materials for the electrically conductive material, the carbon-dioxide adsorbent, or the proton-permeable high-molecular-weight material can be used.

There is no particular limitation regarding a method for producing the composite material, and appropriate selection can be performed in accordance with a purpose. For example, the case where the carbon-dioxide adsorbent is a porous metal complex will be described. The electrically conductive material is dispersed into an aqueous solution containing a metal salt of a central metal of the porous metal complex. Subsequently, the dispersion liquid and a solution containing a ligand of the porous metal complex are mixed and heated (solvothermal method). As a result, a compounded material is produced by compounding the electrically conductive material and the porous metal complex (carbon-dioxide adsorbent). Further, a composite material can be produced by kneading the resulting compounded material and the proton-permeable high-molecular-weight material.

Carbon-Dioxide-Reducing Apparatus

The carbon-dioxide-reducing apparatus according to the present disclosure includes the carbon-dioxide-reducing film as a cathode electrode.

An example of the reaction in the carbon-dioxide-reducing apparatus will be described below. Regarding the anode of the carbon-dioxide-reducing apparatus, for example, decomposition of water described below occurs in response to the light energy applied to the anode electrode.

H₂O→½O₂+2H⁺+2e⁻

On the other hand, regarding the cathode of the carbon-dioxide-reducing apparatus, for example, reduction of carbon dioxide described below occurs.

CO₂+2H⁺+2e⁻→HCOOH

A total reaction formula is, for example, as described below.

H₂O+CO₂→HCOOH+½O₂

The resulting formic acid is concentrated and recovered.

In an aspect of the carbon-dioxide-reducing apparatus according to the present disclosure, a carbon-dioxide-reducing electrode is used as the cathode electrode, and other members, e.g., an anode bath, may be included, as the situation demands. The carbon-dioxide-reducing electrode includes the carbon-dioxide-reducing film according to the present disclosure. The carbon-dioxide-reducing film may be used alone or the carbon-dioxide-reducing film bonded to a conductor may be used as the carbon-dioxide-reducing electrode. There is no particular limitation regarding the conductor, and appropriate selection can be performed in accordance with a purpose. A mesh conductor is preferable from the viewpoint of supplying carbon dioxide and recovering a product. When the carbon-dioxide-reducing electrode includes the conductor and the carbon-dioxide-reducing film in this order, a metal that can reduce carbon dioxide may be included between (at an interface between) the conductor and the carbon-dioxide-reducing film.

Anode Bath

The anode bath includes an anode electrode and may further include other members, as the situation demands. For example, Pt or the like is adopted as the material for forming the anode electrode used in common electrolytic reduction performed by energizing the anode electrode and the cathode electrode by using an external power supply.

Meanwhile, for example, a photoexcitation material, a multi-junction semiconductor, or the like that can cause oxidative decomposition of water is adopted as the material for forming the anode electrode used in electrolytic reduction of carbon dioxide (so-called artificial photosynthesis) which is performed by irradiating the anode electrode with light. Examples of the photoexcitation material include an anode electrode provided with a nitride semiconductor layer.

Other Members

Examples of other members include an anode bath electrolytic solution, a carbon-dioxide supply member, a power supply, and a light source.

Anode Bath Electrolytic Solution

The anode bath electrolytic solution is accommodated in the anode bath. Examples of the anode bath electrolytic solution include a potassium hydrogencarbonate aqueous solution, a sodium hydrogencarbonate aqueous solution, a sodium sulfate aqueous solution, and a sodium hydroxide aqueous solution.

There is no particular limitation regarding the concentration of the electrolyte in the anode bath electrolytic solution, and appropriate selection can be performed in accordance with a purpose. The concentration is preferably 0.2 mol/L or more and more preferably 1 mol/L or more.

Carbon-Dioxide Supply Member

There is no particular limitation regarding the carbon-dioxide supply member as long as the member supplies carbon dioxide to the cathode bath, and appropriate selection can be performed in accordance with a purpose.

Power Supply

There is no particular limitation regarding the power supply as long as the member can apply a direct current, and appropriate selection can be performed in accordance with a purpose.

Light Source

There is no particular limitation regarding the light source, and appropriate selection can be performed in accordance with a purpose. Examples of the light source include a xenon lamp. The light source is used to irradiate the anode electrode with light during electrolytic reduction of carbon dioxide (so-called artificial photosynthesis).

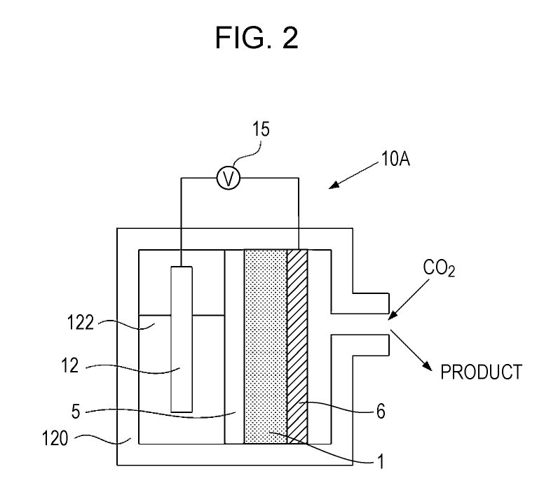

An example of an aspect of the carbon-dioxide-reducing apparatus according to the present disclosure will be described with reference to the drawings. FIG. 2 is a schematic sectional view of a carbon-dioxide-reducing apparatus 10A. The carbon-dioxide-reducing apparatus 10A includes an anode bath 120, a carbon-dioxide-reducing film 1 serving as a cathode electrode, and a conductor 6 in this order. Further, a constant-voltage power supply 15 is included. The carbon-dioxide-reducing film 1 contains the electrically conductive material, the carbon-dioxide adsorbent containing a metal that can reduce carbon dioxide, and the proton-permeable high-molecular-weight material (not illustrated in the drawing). The carbon-dioxide-reducing film 1 is in contact with a substrate (proton-permeable film) 5. An anode bath electrolytic solution 122 is accommodated in the anode bath 120. In the anode bath 120, an anode electrode 12 is dipped in the anode bath electrolytic solution 122.

In the carbon-dioxide-reducing apparatus 10A, a voltage is applied between the carbon-dioxide-reducing film 1 and the anode electrode 12 by the constant-voltage power supply 15. As a result, oxidative decomposition of water occurs at the anode. On the other hand, reduction of carbon dioxide occurs at the cathode. Carbon dioxide is held by the carbon-dioxide-reducing film through the action of the carbon-dioxide adsorbent in the carbon-dioxide-reducing film at the cathode. In addition, the electrical conductivity of the carbon-dioxide-reducing film is enhanced by the electrically conductive material. Further, the cathode is not dipped in the electrolytic solution. Therefore, dissolution of carbon dioxide into the electrolytic solution is decreased, and dissolution of a product into the electrolytic solution is decreased. In addition, contact between the electrolytic solution and the carbon-dioxide adsorbent is decreased by the substrate (proton-permeable film) 5 and, thereby, intrusion of the electrolytic solution into the carbon-dioxide adsorbent may be decreased. Therefore, supply of carbon dioxide to the reaction field and recovery of the product from the reaction field may be efficiently performed.

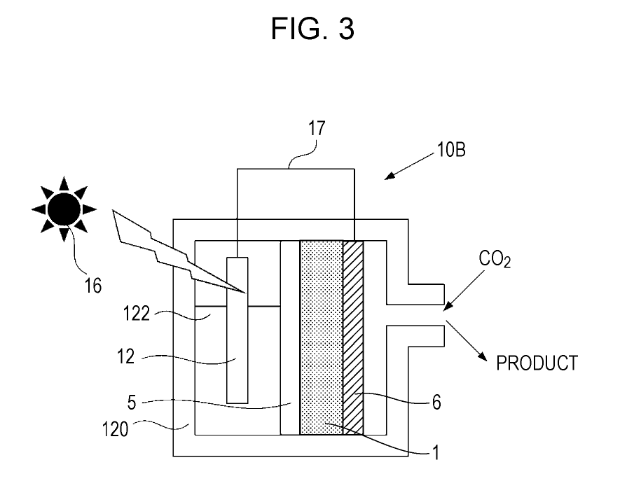

FIG. 3 is a schematic sectional view of a carbon-dioxide-reducing apparatus 10B. The carbon-dioxide-reducing apparatus 10B includes an anode bath 120, a carbon-dioxide-reducing film 1 serving as a cathode electrode, and a conductor 6 in this order. Further, a light source 16 is included. The carbon-dioxide-reducing film 1 contains the electrically conductive material, the carbon-dioxide adsorbent containing a metal that can reduce carbon dioxide, and the proton-permeable high-molecular-weight material (not illustrated in the drawing). The carbon-dioxide-reducing film 1 is in contact with a substrate (proton-permeable film) 5. An anode bath electrolytic solution 122 is accommodated in the anode bath 120. In the anode bath 120, an anode electrode 12 is dipped in the anode bath electrolytic solution 122. The anode electrode 12 is a carbon-dioxide-reducing photochemical electrode.

In the carbon-dioxide-reducing apparatus 10B, the anode electrode 12 is irradiated with the light from the light source 16. As a result, oxidative decomposition of water occurs at the surface of the anode electrode 12. The reaction generates an electromotive force between the anode electrode 12 and the carbon-dioxide-reducing film 1 that are connected to each other by a conducting wire 17. Reduction of carbon dioxide occurs at the cathode in response to the electromotive force. Carbon dioxide is held by the carbon-dioxide-reducing film through the action of the carbon-dioxide adsorbent in the carbon-dioxide-reducing film 1 at the cathode. In addition, the electrical conductivity of the carbon-dioxide-reducing film is enhanced by the electrically conductive material. Further, the cathode is not dipped in the electrolytic solution. Therefore, dissolution of carbon dioxide into the electrolytic solution is decreased, and dissolution of a product into the electrolytic solution is decreased. In addition, contact between the electrolytic solution and the carbon-dioxide adsorbent is decreased by the substrate (proton-permeable film) 5 and, thereby, intrusion of the electrolytic solution into the carbon-dioxide adsorbent may be decreased. Therefore, supply of carbon dioxide to the reaction field and recovery of the product from the reaction field may be efficiently performed.

### EXAMPLES

The technology according to the present disclosure will be described below, but the technology according to the present disclosure is not limited to the following examples.

### Comparative Example 1

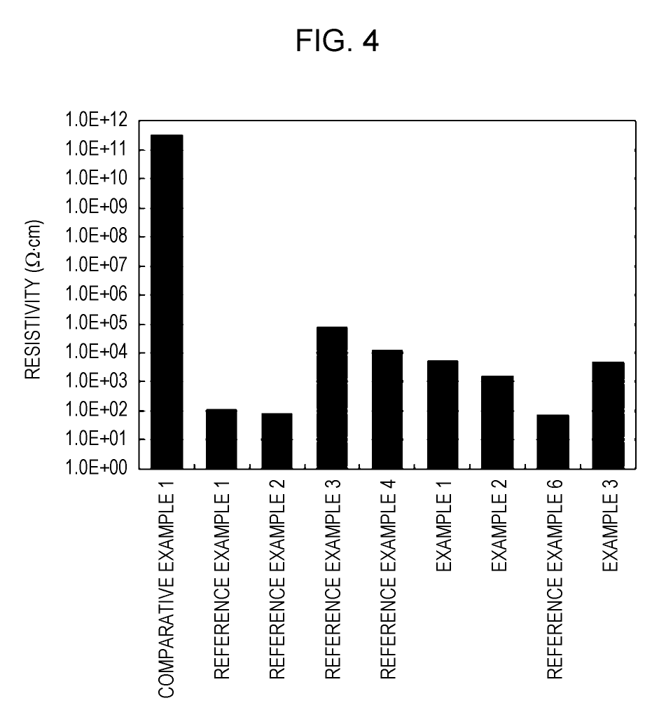

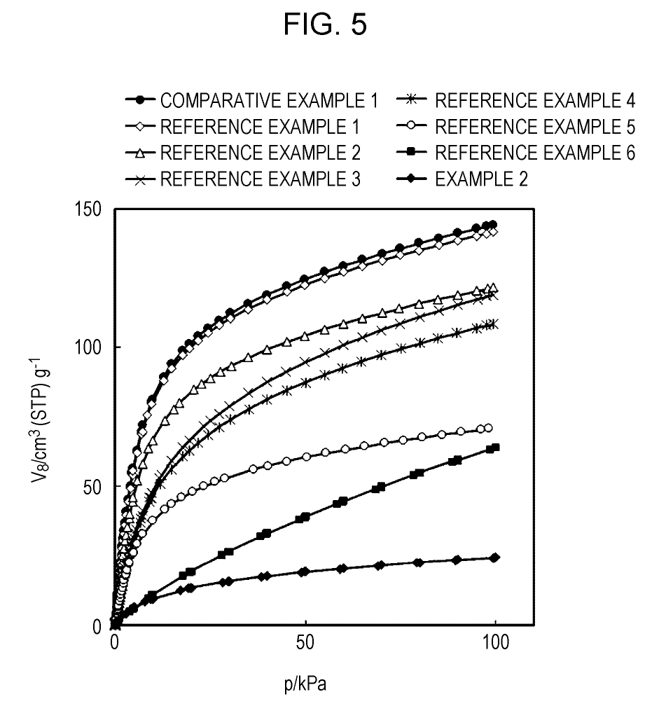

A Ni₂(dobdc) complex serving as a carbon-dioxide adsorbent was synthesized and evaluated. A THF aqueous solution of 2,5-dihydroxyterephthalic acid (structure described below) and an aqueous solution of nickel acetate tetrahydrate were mixed in a molar ratio of 1:2 and heating was performed at 110° C. for 3 days by using a solvothermal method so as to produce a powder sample (yellow powder) of comparative example 1. The resulting powder sample was formed into a pellet having a diameter of 5 mm and an average thickness of 0.3 mm, and electrical resistivity was measured by using an I-V analyzer (B2901A produced by Keysight Technologies Inc.). The result is depicted in Table 1 and FIG. 4. The carbon dioxide adsorption characteristics of the powder sample were measured by using a gas/vapor adsorption measurement instrument (produced by MicrotracBEL Corp.). A carbon dioxide adsorption isotherm is depicted in FIG. 5.

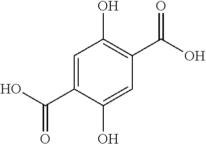 [SMILES: O=C(O)c1cc(O)c(C(=O)O)cc1O]

### Reference Example 1

A sample in which the Ni₂(dobdc) complex produced in comparative example 1 and carbon nanotubes were compounded was prepared by a method described below. The proportion of single-walled carbon nanotubes was set to be 2% by weight relative to the Ni₂(dobdc) complex. Single-walled carbon nanotubes (produced by Meijo Nano Carbon Co., Ltd.) were used as the electrically conductive material. The single-walled carbon nanotubes were dipped into a mixed acid of sulfuric acid and nitric acid in a ratio of 3 to 1 for 1 hour and, thereafter, washing and drying were performed so as to modify the surfaces of the single-walled carbon nanotubes with functional groups, e.g., carboxy groups and hydroxy groups. The modified single-walled carbon nanotubes were added to a nickel acetate aqueous solution, and ultrasonic dispersion was performed. Subsequently, a THF solution of 2,5-dihydroxyterephthalic acid was mixed with nickel acetate to a molar ratio of 2:1, and synthesis was performed by the solvothermal method. In this manner, a powder sample of reference example 1, in which the Ni₂(dobdc) complex and carbon nanotubes were uniformly compounded, was produced. The electrical resistivity of the resulting powder sample of reference example 1 was measured in the same manner as comparative example 1. The result is depicted in Table 1 and FIG. 4. It was clarified that the electrical conductivity was about nine orders of magnitude greater than the electrical conductivity of comparative example 1. The carbon dioxide adsorption characteristics were measured by using the gas/vapor adsorption measurement instrument in the same manner as comparative example 1. A carbon dioxide adsorption isotherm is depicted in FIG. 5. It was ascertained that carbon dioxide adsorptivity was exhibited at a level equal to comparative example 1.

### Reference Example 2

A powder sample of reference example 2 was produced in the same manner as reference example 1, except that the proportion of the single-walled carbon nanotubes was set to be 5% by weight relative to the Ni₂(dobdc) complex. The electrical resistivity of the resulting powder sample of reference example 2 was measured in the same manner as comparative example 1. The result is depicted in Table 1 and FIG. 4. It was clarified that the electrical conductivity was about ten orders of magnitude greater than the electrical conductivity of comparative example 1. The carbon dioxide adsorption characteristics were measured by using the gas/vapor adsorption measurement instrument in the same manner as comparative example 1. A carbon dioxide adsorption isotherm is depicted in FIG. 5. It was ascertained that a little more than 80% of carbon dioxide adsorptivity was exhibited compared with comparative example 1.

### Reference Example 3

A powder sample of reference example 3 was produced in the same manner as reference example 1, except that the single-walled carbon nanotubes in reference example 1 were changed to multi-walled carbon nanotubes (amount of functional groups>8%, produced by Sigma-Aldrich). The electrical resistivity of the resulting powder sample of reference example 3 was measured in the same manner as comparative example 1. The result is depicted in Table 1 and FIG. 4. It was clarified that the electrical conductivity was about seven orders of magnitude greater than the electrical conductivity of comparative example 1. The carbon dioxide adsorption characteristics were measured by using the gas/vapor adsorption measurement instrument in the same manner as comparative example 1. A carbon dioxide adsorption isotherm is depicted in FIG. 5. It was ascertained that about 80% of carbon dioxide adsorptivity was exhibited compared with comparative example 1.

### Reference Example 4

A powder sample of reference example 4 was produced in the same manner as reference example 3, except that the proportion of the multi-walled carbon nanotubes in reference example 3 was set to be 5% by weight relative to the Ni₂(dobdc) complex. The electrical resistivity of the resulting powder sample of reference example 4 was measured in the same manner as comparative example 1. The result is depicted in Table 1 and FIG. 4. It was clarified that the electrical conductivity was about eight orders of magnitude greater than the electrical conductivity of comparative example 1. The carbon dioxide adsorption characteristics were measured by using the gas/vapor adsorption measurement instrument in the same manner as comparative example 1. A carbon dioxide adsorption isotherm is depicted in FIG. 5. It was ascertained that a little more than 70% of carbon dioxide adsorptivity was exhibited compared with comparative example 1.

It was found from comparisons between comparative example 1 and reference examples 1 to 4 that, regarding the same type of carbon nanotubes, the electrical conductivity increased as the amount of introduction increased. In addition, it was found that the powder sample including the single-walled carbon nanotubes had higher electrical conductivity than the powder sample including the multi-walled carbon nanotubes, when the proportion of the single-walled carbon nanotubes and the proportion of the multi-walled carbon nanotubes were the same in compounding. Consequently, it is conjectured that the contact area between the porous metal complex powder and carbon nanotubes contributes to the electrical conductivity.

TABLE 1

| | | Amount | | | |
|---|---|---|---|---|---|
| | | of intro- | | | |
| | Electrically | duction | | | Electrical |
| | conductive | (% by | Resistance | Resistivity | conductivity |
| | material | weight) | (Ω) | (Ω · cm) | (S/cm) |
| Com- | — | — | 5.36E+10 | 3.51E+11 | 2.85E−12 |
| parative | | | | | |
| example 1 | | | | | |
| Reference | single- | 2 | 1.80E+01 | 1.18E+02 | 8.50E−03 |
| example 1 | walled CNT | | | | |
| Reference | (mixed acid | 5 | 1.30E+01 | 8.52E+01 | 1.17E−02 |
| example 2 | treatment) | | | | |
| Reference | multi-walled | 2 | 1.28E+04 | 8.39E+04 | 1.19E−05 |
| example 3 | CNT | | | | |
| Reference | (—COOH | 5 | 1.92E+03 | 1.26E+04 | 7.95E−05 |
| example 4 | modified) | | | | |
| Example 1 | single- | 2 | 8.29E+02 | 5.43E+03 | 1.84E−04 |
| Example 2 | walled CNT | 5 | 2.54E+02 | 1.66E+03 | 6.02E−04 |
| | (mixed acid | | | | |
| | treatment) | | | | |
| Reference | activated | — | 1.22E+01 | 7.96E+01 | 1.26E−02 |
| example 6 | carbon | | | | |
| Example 3 | (adsorbent | — | 7.91E+02 | 5.18E+03 | 1.93E−04 |
| | itself) | | | | |

In the table, E represents an exponent of 10 and, for example, E+02 represents 10².

### Reference Example 5

A sample in which the Ni₂(dobdc) complex produced in comparative example 1 and Nafion (registered trademark) serving as a proton-permeable high-molecular-weight material were compounded was prepared by a method described below. The proportion of Nafion was set to be 30% by weight relative to the Ni₂(dobdc) complex. Mixing and kneading of 0.07 g of Ni₂(dobdc) powder, 0.15 g of 20-% Nafion dispersion solution (produced by Wako Pure Chemical Industries, Ltd.), and a small amount of methanol were performed, and heat-drying at 100° C. was performed so as to produce a solid sample in which the Ni₂(dobdc) complex and Nafion colloids were uniformly compounded. The resulting solid sample was ground into a powder so as to produce a powder sample of reference example 5. The carbon dioxide adsorption characteristics of the resulting powder sample were measured by using the gas/vapor adsorption measurement instrument in the same manner as comparative example 1. A carbon dioxide adsorption isotherm is depicted in FIG. 5. It was ascertained that the total amount of adsorption was about 50% compared with comparative example 1 and the adsorption characteristics were maintained.

### Reference Example 6

A powder was prepared as a sample, in which an adsorbent itself had electrical conductivity and also served as an electrically conductive material, by grinding activated carbon (fibrous activated carbon FR-20 produced by Kuraray Co., Ltd.) in a jet mill. The electrical resistivity of the resulting powder sample of reference example 6 was measured in the same manner as comparative example 1. The result is depicted in Table 1 and FIG. 4. It was clarified that the electrical conductivity was about ten orders of magnitude greater than the electrical conductivity of comparative example 1 and on the order of the electrical conductivity of reference example 2. The carbon dioxide adsorption characteristics were measured by using the gas/vapor adsorption measurement instrument in the same manner as comparative example 1. A carbon dioxide adsorption isotherm is depicted in FIG. 5. It was ascertained that a little less than 50% of carbon dioxide adsorptivity was exhibited compared with comparative example 1.

### Comparative Example 2

In order to evaluate the proton conductivity of a Nafion film (Nafion 117 produced by Sigma-Aldrich) alone, an alternating current impedance was measured by using an electrochemical test system (Modulab XM ECS produced by Solartron). Two terminals of electrodes were connected to a sample film (thickness of 183 μm) in the thickness direction, and measurement was performed in a frequency range of 1 MHz to 0.1 Hz and an applied voltage range of 0 to 1 V. The proton conductivity was calculated from a resistance value determined based on the x intercept of a Nyquist plot, the length of conduction path of the sample, and the cross-sectional area. As a result, the value was 5×10⁻³ S/cm (refer to Table 2).

### Comparative Example 3

Methanol was added to only the Ni₂(dobdc) complex of comparative example 1 and kneading was performed. A Nafion film was coated with the kneaded material and drying was performed so as to produce a sample film. The proton conductivity of the resulting complex sample was determined by the same method as comparative example 2, but no value was obtained because of large resistance.

### Comparative Example 4

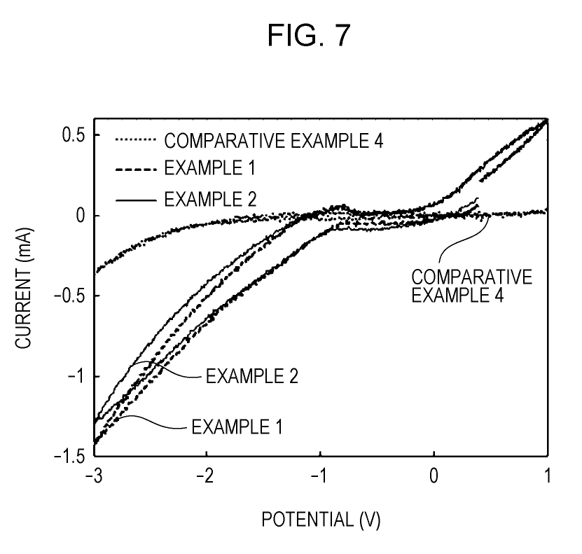

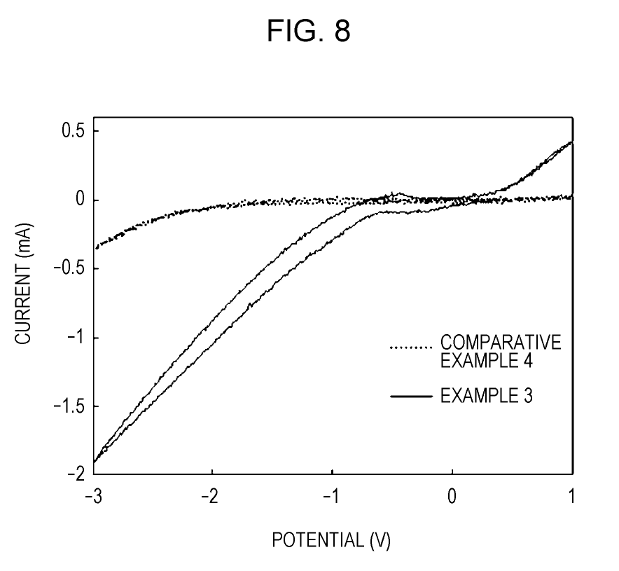

Carbon paper (Torayca Carbon Paper produced by Toray Industries, Ltd.) was dipped into a mixed acid of sulfuric acid and nitric acid in a ratio of 3 to 1 for 30 minutes and, thereafter, washing was performed so as to modify the carbon paper with functional groups, e.g., carboxy groups. A potential of −0.8 V was applied to the resulting carbon paper for 10 seconds in an electrolytic solution containing 12.5 mM of copper sulfate and 0.5 M of sulfuric acid such that copper fine particles serving as a reducing catalyst were carried on the surface of the carbon paper. The resulting carbon paper was used as a cathode electrode, and the electrolytic reduction behavior of CO₂ in the presence of no adsorbent by using the carbon-dioxide-reducing apparatus illustrated in FIG. 2 was evaluated by an electrochemical method. In the carbon-dioxide-reducing apparatus, an anode bath and a cathode bath were isolated from each other by a proton-conductive film (Nafion 117). In the anode bath, a 0.2-M potassium hydrogencarbonate aqueous solution serving as the electrolytic solution and a platinum anode electrode were disposed. The electrolytic solution was not included in the cathode bath, the carbon paper cathode electrode was disposed in close contact with the proton-conductive film, and the inside of the bath was substituted with CO₂. The results of cyclic voltammetry measurement by using this reaction apparatus are illustrated in FIGS. 7 and 8.

### Example 1

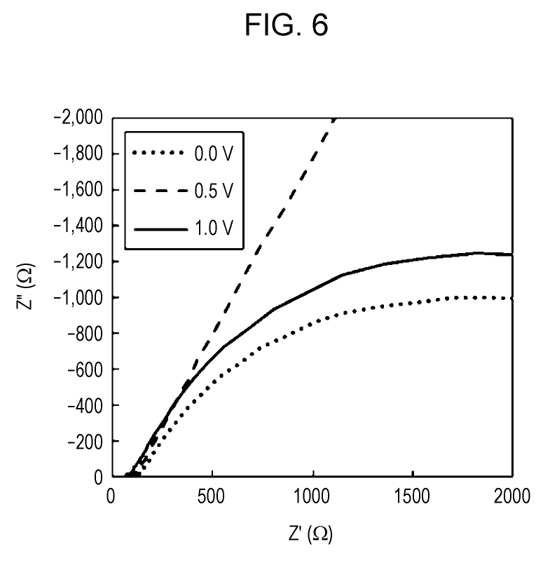

A carbon-dioxide-reducing film of example 1, in which the powder of reference example 1 and Nafion were compounded, was produced by the following method. The proportion of Nafion was set to be 40% by weight relative to the powder of reference example 1. Mixing and kneading of 0.06 g of the powder of Ni₂(dobdc)+single-walled CNT (2% by weight) which was the powder of reference example 1, 0.2 g of 20-% Nafion dispersion solution (produced by Wako Pure Chemical Industries, Ltd.), and a small amount of methanol were performed. A Nafion film having an area of 300 mm×400 mm was coated with the resulting kneaded material, and thermocompression bonding at 100° C. and drying were performed so as to produce an integrally formed carbon-dioxide-reducing film of example 1. The electrical resistivity of the resulting carbon-dioxide-reducing film of example 1 was measured in the same manner as comparative example 1. The result is depicted in Table 1 and FIG. 4. It was clarified that the electrical conductivity was about eight orders of magnitude greater than the electrical conductivity of comparative example 1. The proton conductivity of this sample was determined by the same method as comparative example 2. The result is depicted in FIG. 6 and Table 2. The electrolytic reduction behavior of CO₂ by the carbon-dioxide-reducing film was evaluated in the same manner as comparative example 4. The carbon-dioxide-reducing apparatus illustrated in FIG. 2 was used, the sample film was arranged as a partition between the anode and cathode, the carbon paper cathode electrode was arranged in close contact with the surface of the sample film with the adsorbent stacked, and cyclic voltammetry measurement was performed. The measurement condition was in conformity with comparative example 4. As a result, oxidation-reduction current was increased compared with comparative example 4 in which the adsorbent was not arranged and, therefore, it was ascertained that carbon dioxide efficiently reacted through the action of the carbon-dioxide-reducing film configured to use the adsorbent (refer to FIG. 7).

TABLE 2

| | Amount of Nafion added | Proton conductivity |
|---|---|---|
| | (%) | (S/cm) |
| Comparative example 2 | 100 (Nafion alone) | 5 × 10⁻³ |
| Comparative example 3 | 0 (complex alone) | — |
| Example 1 | 40 | 2 × 10⁻⁴ |

### Example 2

A carbon-dioxide-reducing film of example 2 was produced in the same manner as example 1, except that the powder of Ni₂(dobdc)+single-walled CNT (5% by weight) which was the powder of reference example 2 was used in example 1. The electrical resistivity of the resulting carbon-dioxide-reducing film was measured in the same manner as example 1. The result is depicted in Table 1 and FIG. 4. The carbon dioxide adsorption characteristics were measured by using the gas/vapor adsorption measurement instrument in the same manner as comparative example 1. A carbon dioxide adsorption isotherm is depicted in FIG. 5. It was ascertained that the total amount of adsorption was decreased but a little less than 20% of carbon dioxide adsorptivity was exhibited compared with comparative example 1. The electrolytic reduction behavior of CO₂ by the carbon-dioxide-reducing film was evaluated in the same manner as example 1. As a result, a difference in oxidation-reduction current was increased compared with example 1 and, therefore, it was ascertained that reduction of carbon dioxide was facilitated in accordance with high electrical conductivity (refer to FIG. 7).

### Example 3

A carbon-dioxide-reducing film of example 3 was produced in the same manner as example 1, except that activated carbon which was the powder of reference example 6 was used as the carbon-dioxide adsorbent in example 1. The electrical resistivity of the resulting carbon-dioxide-reducing film was measured in the same manner as example 1. The result is depicted in Table 1 and FIG. 4. The electrolytic reduction behavior of CO₂ by the carbon-dioxide-reducing film was evaluated in the same manner as examples 1 and 2. As a result, the oxidation-reduction current was increased compared with comparative example 4 and, therefore, it was ascertained that carbon dioxide efficiently reacted through the action of the carbon-dioxide-reducing film configured to use the adsorbent (refer to FIG. 8).

It was made possible to further provide proton conductivity by producing a composite film of Nafion and a powder that was provided with electrical conductivity by adding carbon nanotubes to the Ni₂(dobdc) complex having high carbon dioxide adsorptivity.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. A carbon-dioxide-reducing film comprising:
an electrically conductive material including at least one selected from a group consisting of carbon nanotubes, nanographenes, and carbon paper;
a carbon-dioxide adsorbent; and
a proton-permeable high-molecular-weight material.

2. The carbon-dioxide-reducing film according to claim 1, comprising:
the electrically conductive material configured to be at least one selected from a group consisting of single-walled carbon nanotubes having carboxy groups on the surfaces and multi-walled carbon nanotubes having carboxy groups on the surfaces.

3. The carbon-dioxide-reducing film according to claim 1, comprising:
the carbon-dioxide adsorbent configured to include a metal that reduces carbon dioxide and a ligand that coordinate with the metal.

4. The carbon-dioxide-reducing film according to claim 1,
wherein the content of the electrically conductive material is 1% by mass to 10% by mass relative to the carbon-dioxide adsorbent.

5. The carbon-dioxide-reducing film according to claim 3,
wherein the metal is at least one selected from a group consisting of nickel, copper, zinc, magnesium, iron, and cobalt.

6. The carbon-dioxide-reducing film according to claim 3,
wherein the ligand has at least one selected from a group consisting of a carboxy group, a hydroxy group, an amino group, an imino group, a thiol group, a carboxylate group, and an oxime group.

7. The carbon-dioxide-reducing film according to claim 3,
wherein the ligand has
at least one aromatic hydrocarbon ring, and
two pairs of a carboxy group and a hydroxy group, the two pairs being bonded to the at least one aromatic hydrocarbon ring, where a carboxy group of one pair of a carboxy group and a hydroxy group is bonded to one carbon atom of two adjacent carbon atoms of the at least one aromatic hydrocarbon ring, and a hydroxy group of the one pair is bonded to the other carbon atom, and the other pair is identical.

8. The carbon-dioxide-reducing film according to claim 1,
wherein the proton-permeable high-molecular-weight material has
a skeleton containing fluorine atoms and carbon atoms, and
a perfluoro side chain having a sulfonate group.

9. The carbon-dioxide-reducing film according to claim 1,
wherein the content of the proton-permeable high-molecular-weight material is 20% by mass to 70% by mass.

10. A manufacturing method for a carbon-dioxide-reducing film, the method comprising:
coating a substrate with a composite material including an electrically conductive material, a carbon-dioxide adsorbent, and a proton-permeable high-molecular-weight material; and
heating the substrate at a temperature from 100° C. to 250° C.

11. The manufacturing method according to claim 10,
wherein the substrate includes a proton-permeable high-molecular-weight material.

12. A carbon-dioxide-reducing apparatus comprising:
a carbon-dioxide-reducing electrode configured to include a carbon-dioxide-reducing film and to serve as a cathode electrode,
the carbon-dioxide-reducing film configured to include
an electrically conductive material including at least one selected from a group consisting of carbon nanotubes, nanographenes, and carbon paper,
a carbon-dioxide adsorbent, and
a proton-permeable high-molecular-weight material.

13. The carbon-dioxide-reducing apparatus according to claim 12,
wherein the carbon-dioxide-reducing electrode includes a conductor and the carbon-dioxide-reducing film,
the carbon-dioxide-reducing electrode contains a metal that reduces carbon dioxide, and
the metal that reduce carbon dioxide is included in at least one of the carbon-dioxide adsorbent and an interface between the conductor and the carbon-dioxide-reducing film.

14. A carbon-dioxide-reducing apparatus comprising:
a cathode electrode bonded with a carbon-dioxide-reducing film, the carbon-dioxide-reducing film includes
an electrically conductive material including at least one selected from a group consisting of carbon nanotubes, nanographenes, and carbon paper,
a carbon-dioxide adsorbent, and
a proton-permeable high-molecular-weight material; and
an anode electrode.

15. The carbon-dioxide-reducing apparatus according to claim 14, wherein the electrically conductive material includes at least one selected from a group consisting of single-walled carbon nanotubes having carboxy groups on the surfaces and multi-walled carbon nanotubes having carboxy groups on the surfaces.

16. The carbon-dioxide-reducing apparatus according to claim 14, wherein the carbon-dioxide adsorbent includes a metal that reduces carbon dioxide and a ligand that coordinate with the metal.

17. The carbon-dioxide-reducing apparatus according to claim 14, wherein the content of the electrically conductive material is 1% by mass to 10% by mass relative to the carbon-dioxide adsorbent.

18. The carbon-dioxide-reducing apparatus according to claim 16, wherein the metal is at least one selected from a group consisting of nickel, copper, zinc, magnesium, iron, and cobalt.

19. The carbon-dioxide-reducing apparatus according to claim 16, wherein the ligand has at least one selected from a group consisting of a carboxy group, a hydroxy group, an amino group, an imino group, a thiol group, a carboxylate group, and an oxime group.

20. The carbon-dioxide-reducing apparatus according to claim 14, wherein the content of the proton-permeable high-molecular-weight material is 20% by mass to 70% by mass.
